(19) United States
(12) Patent Application Publication
(10) Pub. No.: US 2017/0031230 A1
(43) Pub. Date: Feb. 2, 2017

(54) LIGHT TRANSMISSIVE DOOR, WINDOW, AND/OR SHIELD PROJECTION SYSTEM AND METHOD

(71) Applicant: Kevin PARK, Fremont, CA (US)

(72) Inventor: Kevin PARK, Fremont, CA (US)

(21) Appl. No.: 14/813,065

(22) Filed: Jul. 29, 2015

(51) Int. Cl. G02F 1/17; G03B 21/62

(52) U.S. Cl. CPC G02F 1/17; G03B 21/62

(57) ABSTRACT

An apparatus for projecting information about items on display is disclosed. The apparatus allows product visibility behind a variably translucent projection screen.

### FIELD OF THE INVENTION

This invention relates to item display cases, rooms, and stands, and more particularly, to display cases, rooms, and stands having an active display system.

### BACKGROUND

As stores and other locations selling items want to present their items for sale in ways that customers can readily find value and make comparisons, different signage techniques have developed. The simplest signage technique is to place a placard or fixed label in proximity to an item for sale. This allows a potential customer to identify some features about the item for sale and determine its selling price.

However, printing, deploying, and arranging fixed signage can take time, which complicates adjustments to inventory and cost structure. Additionally, customers may want details that are not readily available with a simple placard. A need exists to have the option of displaying more complex and up to date information to customers than is practical with printed signs and placards.

### SUMMARY OF THE INVENTION

The need is met with the present invention. In a preferred embodiment, a projector is used to illuminate a translucent film, showing an image in proximity to a product being displayed. Various embodiments allow projecting an image on the door of a display case containing a product for sale, the window of a store or restaurant, and a shield screen at a kiosk.

Other advantages of the invention will become apparent from the following description.

### BRIEF DESCRIPTION OF THE DRAWINGS

FIG. 1a is a prior art display case;

FIG. 1b is a prior art display case as in FIG. 1a but with the door open;

FIG. 2a is a display case with projector and screen according to the invention;

FIG. 2b is a display case as in FIG. 2a but with the projector turned on and a product on display;

FIG. 2c is a display case as in FIG. 2b but with the screen and image on display taking up an entire window;

FIG. 3 shows alternative possible arrangements of the projector and display case door or window;

FIG. 4 shows a sample placement of a projector and shield screen at a kiosk; and

FIG. 5 shows a sample placement of a projector and shield screen at a restaurant.

### DETAILED DESCRIPTION

### Prior Art

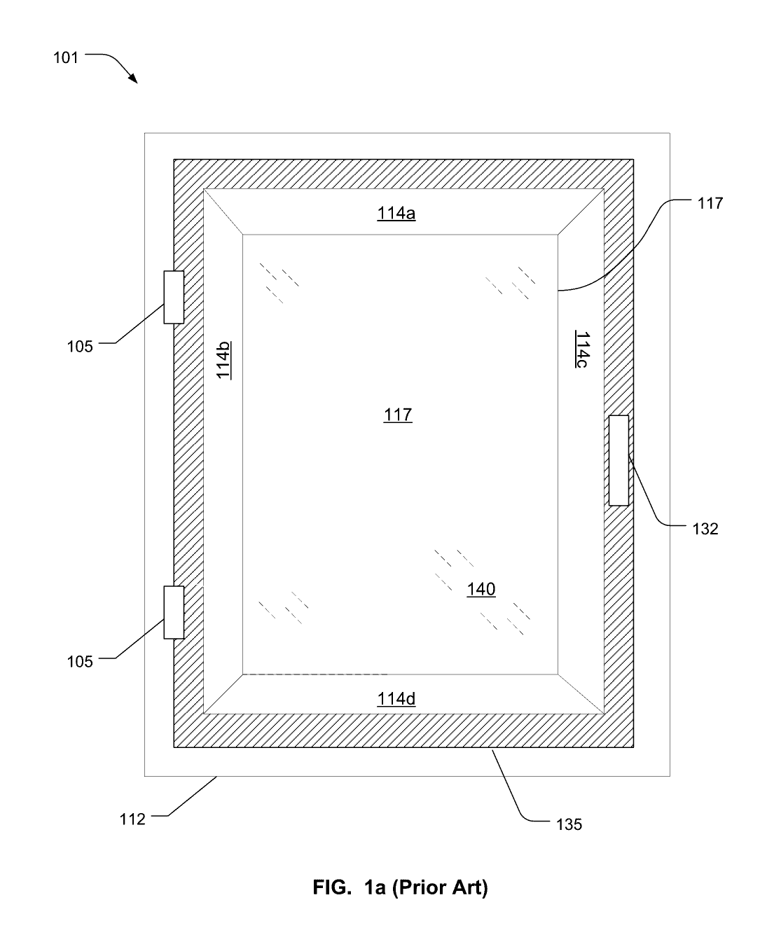

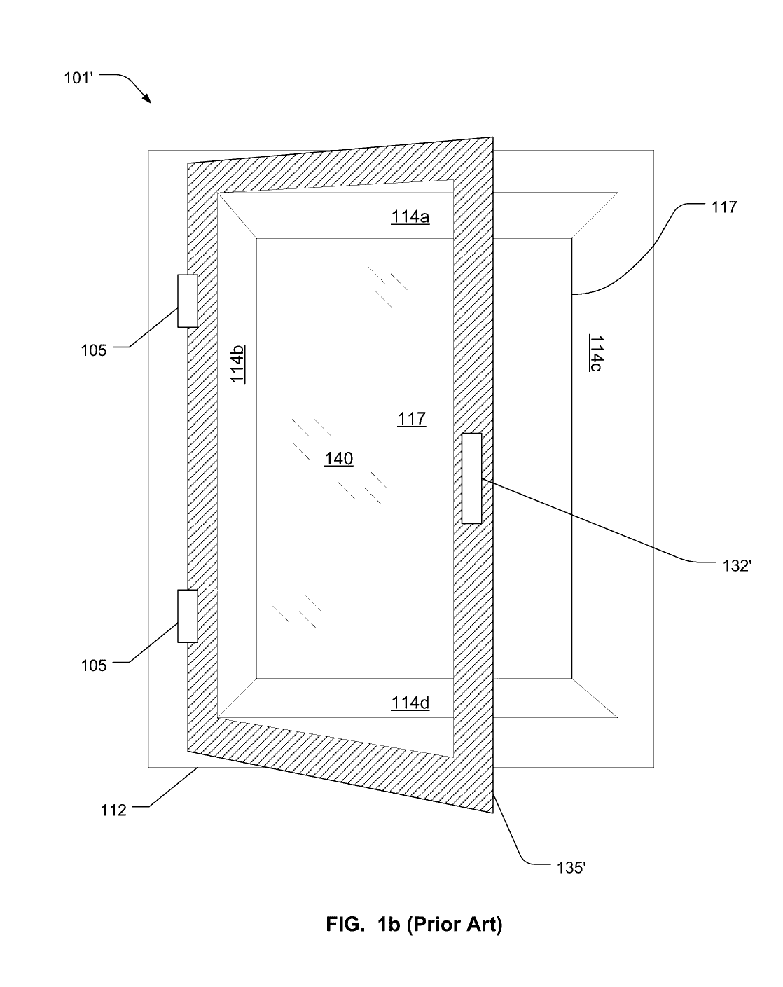

Referring to FIG. 1a, a typical prior art display case is shown as structure 101, facilitating placement of a product for sale. In this simplified portrayal, the empty case 101 features sidewalls 114 and back wall 117 along with frame 112 and door 135 supported by hinges 105. As is common in the art, this type of assembly may support shelving (not shown). A handle 132 allows opening the door 135. Other means of opening a door are possible including having a sliding door on rollers, or instead of a handle, an indentation in the door.

Referring to FIG. 1b, the typical prior art display case 101′ is shown with the door 135′ open.

### Inventive Embodiments

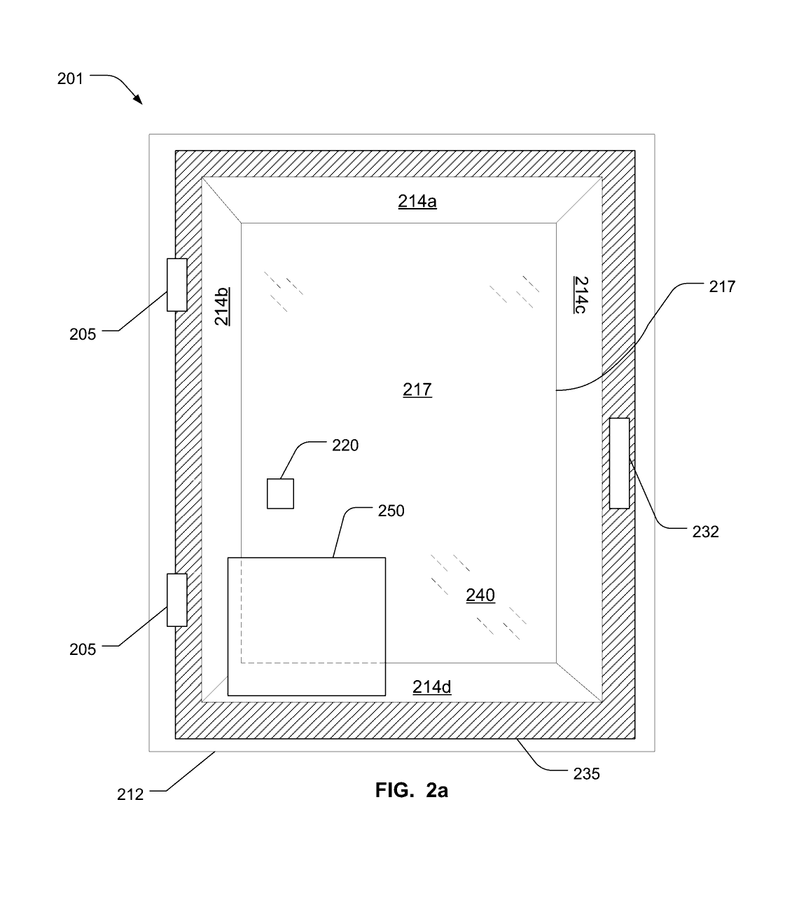

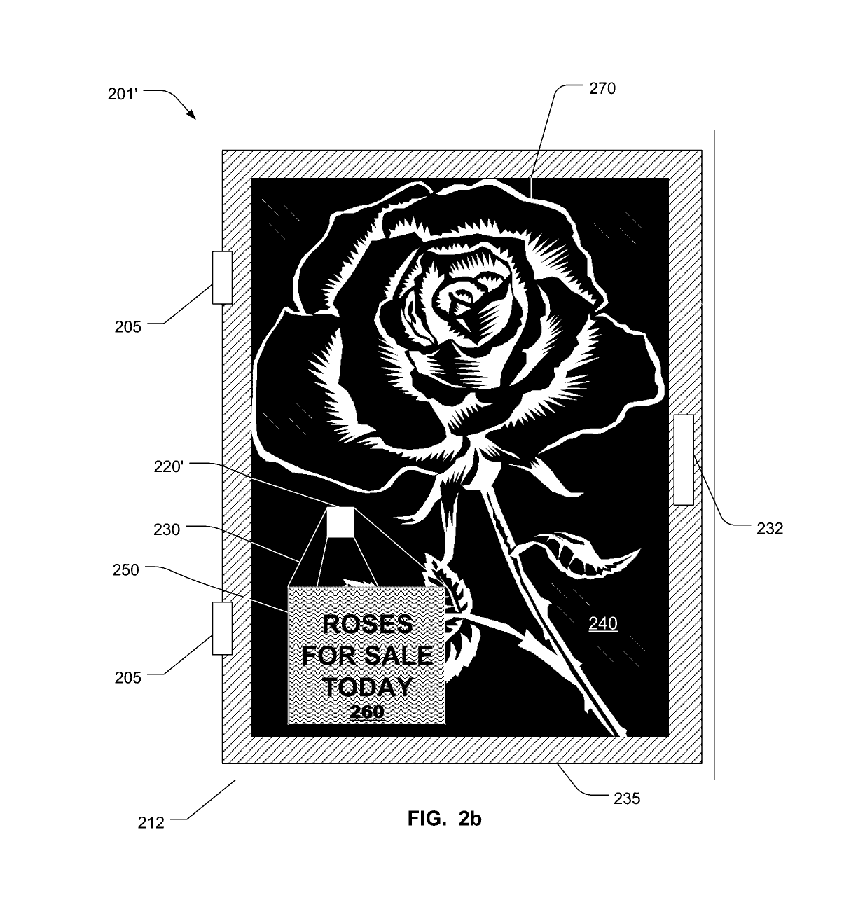

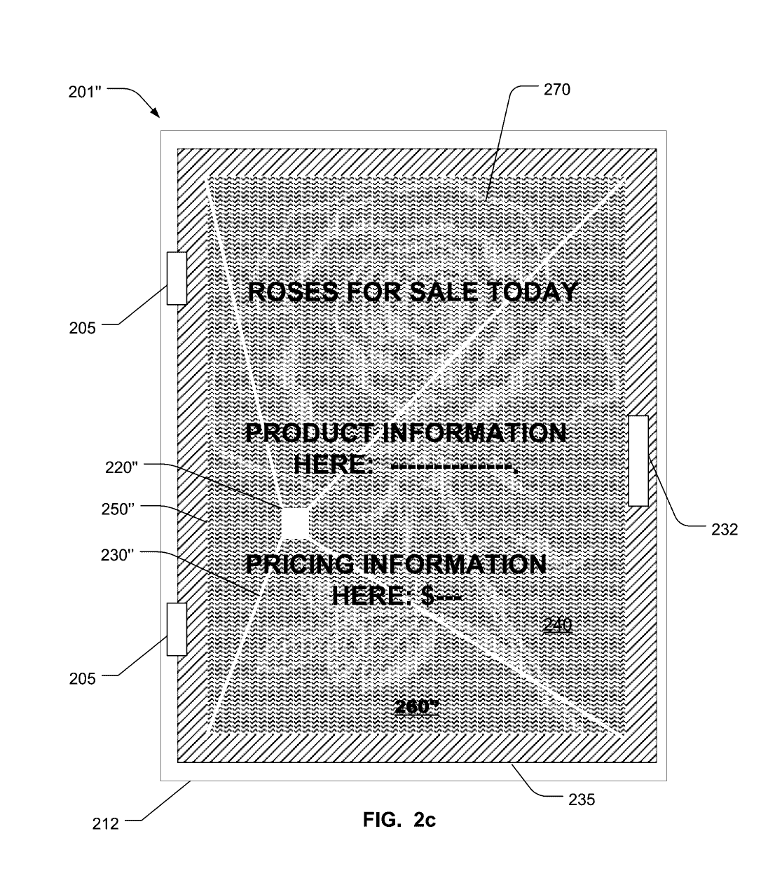

FIG. 2a shows an embodiment of the present invention, featuring an active display case 201 including a projector 220 and screen 250. Here, the sidewalls 214 and back wall 217 provide room to contain a product for sale. Beyond what is visible to a shopper, the structure defined in part by walls 214 and 217 may be attached to or in contact with a support structure (not shown). Appropriate display case support structures are well known in construction practice.

Frame 212 supports door 235 via hinges 205. Appropriate display case door and hinge mechanisms are well known in the art. A light transmissive cover 240 may be present. This cover 240 may block access to the product for sale unless door 235 is opened, or alternatively if the cover 240 is slid away. Cover 240 may also serve the purpose of keeping temperature controlled air within. Various light transmissive materials may be used for cover 240, for example glass or plastic.

Also featured is screen 250, which may be made of “Sticky Screen” rear projection screen window film material, available from Goo Systems of Kingston, Ontario, Canada. Alternatively, a variable translucence material, for example a switchable smart film as manufactured by Pro Display of South Yorkshire in the United Kingdom, may be used as a screen material. A preferred screen material has the property of being a holographic film with about 80% transmission rate. The screen 250 material may be affixed to light transmissive cover 240 or attached nearby the case 201 even if there is not a cover 240.

Alternatively the screen 250 could be an interactive information display, like a tablet PC.

FIG. 2a portrays a screen 250 which does not cover the entire surface of the window 240. However, it should be understood that the screen may cover all or part of the window 250.

A projector 220 (here shown turned off) is positioned to illuminate the screen 250. It is possible to use a short-throw unit as projector 220, for example model PJD8653ws as made by ViewSonic of Walnut, Calif. Placement of the projector 220 as shown in FIGS. 2a through 2c is for example purposes only and the projector could be placed elsewhere within display case 201. Alternatively, for increased distance between projector 220 and screen 250, projector 220 could be a regular throw projector, for example ViewSonic type PJD7533w. The ViewSonic projector family brochure provides guidance about projector type and practical throw distance.

Referring to FIG. 2b, the display case 201 as in FIG. 2a is labeled with a prime symbol 201′ showing active use of the projector 220′. Here, an item 270 is shown in the case for example purposes. It should be noted that this is not the only possible item that could be for sale or display. Other possibilities include multiple items on multiple shelves. The projector 220′ is shown emitting rays 230 onto the screen 250′, producing image 260. An optional link (not shown) can be made available to select whether and what image to display, under control from an external source. Alternatively, an internal computer or digital control means (also not shown) may be adapted to provide image control. Means for remote or local control of a projector are well known in the art.

Referring to FIG. 2c, the display case 201 as in FIG. 2a is labeled with a double prime symbol 201″ showing active use of the projector 220″, this time to display an image on a screen 250″ covering the entire window of the display case 201″. While the image 260″ brightness level is shown such that the item 270 for sale is visible through the screen 250″, the brightness level could be changed to essentially make image 260 the only visible feature on screen 250 or window 240. Also, any interior lighting (not shown) within display case 201 could be turned off to enhance the effect of screen 250 brightness.

It should be noted that in FIGS. 2b and 2c, the wording variations in image 260 on screen 250 are shown for example only and could be changed according to the type of product on display, what a viewer needs to know, and information a seller wishes to provide. Also, images of objects as well as text may be displayed on screen 250. Though per Patent Office drawing guidelines, the sample images are shown in variations on black and white, in reality color text, object images, and backgrounds could be displayed.

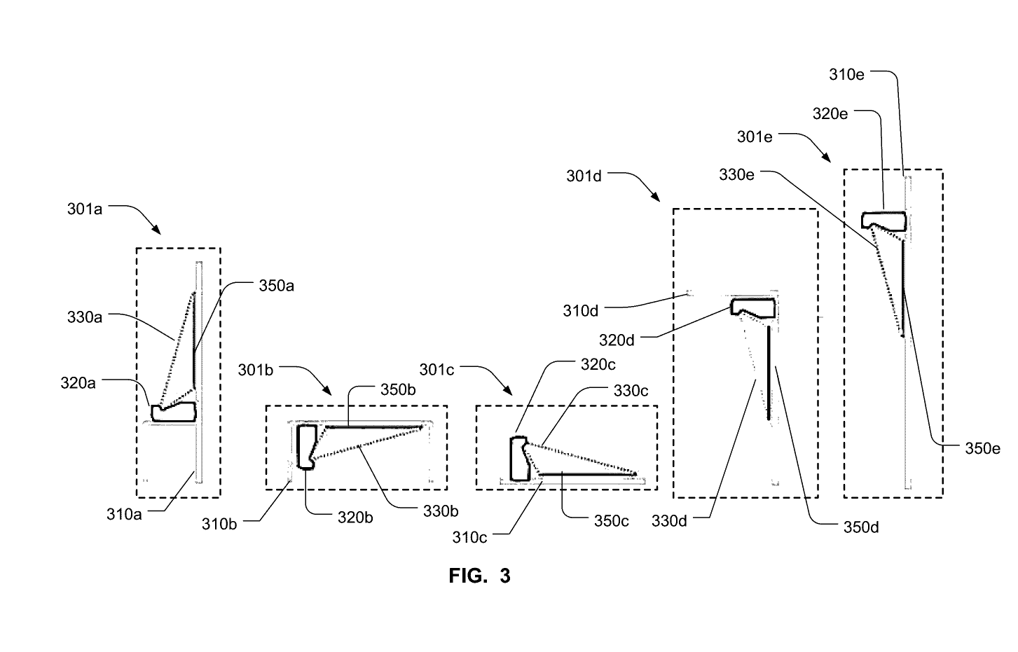

Referring to FIG. 3, various configurations within dashed line boxes 301a through 301e depict variants of a basic structure 310 supporting a projector 320 and screen 350. Here, in contrast with FIGS. 1 and 2, which show a display case but not a support structure, FIG. 3 shows various support structures but not a display case. It is understood that this basic support structure 310 may be surrounded by a display case (again, not shown in FIG. 3). However, even without a display case, it is possible to market a product using just this arrangement.

In some variations, for example 301b and 301c, providing a case door that opens above the items being displayed may be helpful. Other display cases may have a horizontally opening door to go along with the arrangements in FIGS. 301a, 301d, and 301e. Door angles that are intermediate between horizontal and vertical are possible. Also the projector 320 may be in front of or behind the display screen 350, relative to the customer.

Further, though the screen 250 is shown attached to an optical cover 240 in turn supported by a door 235, it is not required that screen 250 or optical cover 240 be movable relative to structure frame 212. The screen 250 and optical cover 240 could be fixedly attached as a window to frame 250. However, various window mounting techniques, including some which allow relative motion between window and frame, are known in the art.

### Dynamic Operation and Control Strategy

Referring back to FIGS. 2a and 2b, to allow remote control, an optional control interface may activate the projector in coordination with the variably light transmissive screen 250. Alternatively there could be an onboard control system that autonomously controls the projector and variable light transmissive screen.

Regardless of whether the control mechanism is external or on board a display case, several methods are possible to coordinate use of the projector 220 with screen 250. Operationally, the store owner may advantageously apply several different scenarios in using this system to market product 270.

For simple instances, the projector 220 could be on all the time, allowing a screen 250 to be made of a steadily or constantly frosted or translucent material. Alternatively a static image, as from a photographic slide, could be projected on the screen at will.

In more complex control scenarios, the projector 220 may be illuminated depending on external conditions (for example, whether from a store owner command, or a sensor turning it on in response to passerby). Alternatively or in combination, if screen 250 is made of variable light transmissive material, various sensor or control signals may cause that material to change state from transparent to show direct product view, to translucent allowing projection of an image near, even in front of, the one or more items for sale.

When the store owner wishes to display product information, the variable translucence could be made suitable for displaying an image at predetermined intervals, as with a timer, or coordinated from a central command post to be activated, possibly in combination with a voice message drawing attention to products.

Alternatively, the display mechanism could be activated by the approach of one or more shoppers. Further, a touch panel mechanism could allow the shopper to push one or more regions on the display screen 250 to obtain information.

From this discussion it can be seen that advantages are present from this arrangement. While it is believed most practical to project the image 260 on a door of the display case 201, this is not necessarily the only arrangement. Other arrangements exist, as shown in FIG. 3, where an image is projected near the product being displayed.

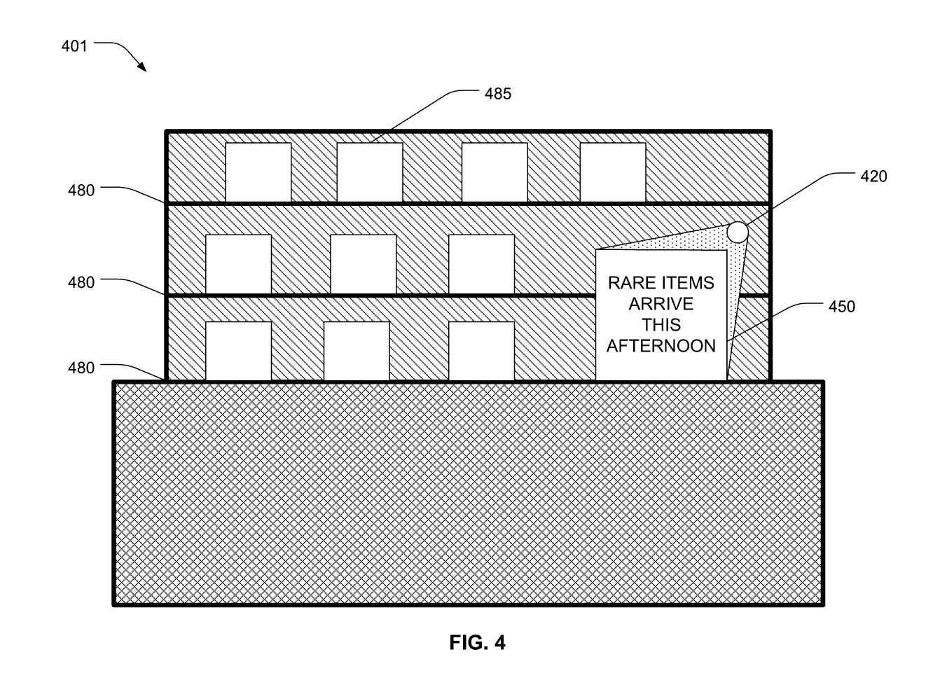

Additionally, the projector and screen could be deployed in other environments as well as in other configurations. FIG. 4 shows a projector and screen embodiment as might be deployed at a stand 401 presenting items for sale 485. The projector 420 projects an image onto screen 450 which is placed in the form of a shield in front of items for sale 485 on shelves 480. Supporting transparent material can be used to reinforce screen 450.

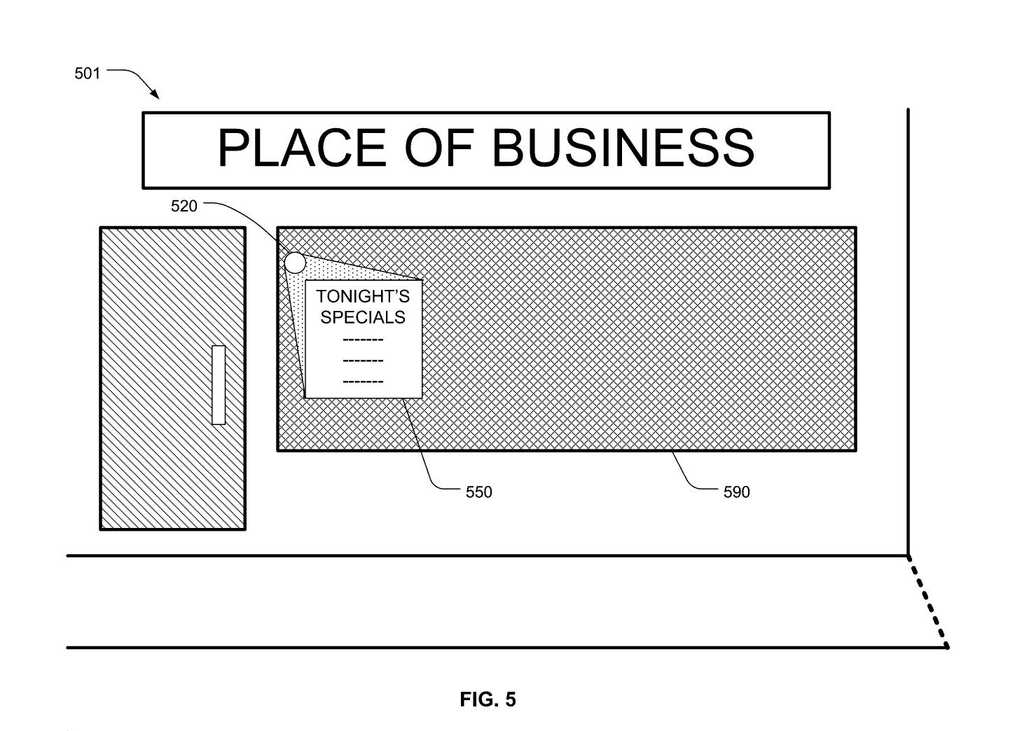

In yet a further embodiment, FIG. 5 shows a projector 520 and screen 550 as could be used with a window 590 in a room at a building 501, for example that of a restaurant.

### CONCLUSIONS, RAMIFICATIONS, AND SCOPE

Though only one projector is shown in the sample embodiments, conceivably more than one projector could be added to cover more than one part of a screen, more than one screen, or to cover more than one shelf, for display cases having shelves.

While usage of the projection system is presented within a sales context, the system could also be used in other contexts, for example at a museum where the system would present information about items on display.

The spirit of the present invention provides a breadth of scope that includes all methods of making and using it. Any variation on the theme and methodology of accomplishing the same that are not described herein would be considered under the scope of the present invention. Although several specific embodiments of the invention are described and illustrated above, the invention is not to be limited to the specific forms or arrangements of parts so described and illustrated. For example, differing configurations, sizes, or materials may be used to practice the present invention.

From the foregoing, it will be appreciated that the present invention is novel and offers advantages over the current art. The invention is limited by the claims that follow.

What is claimed is:

1. A projection system capable of superimposing a lighting pattern on a display case window, comprising:
a projector; and
a variable translucence material on the door window.

2. The projection system capable of superimposing a lighting pattern on a display case window as in claim 1, further comprising;
an automatic control system.

3. The projection system capable of superimposing a lighting pattern on a display case window as in claim 1, further comprising;
a sensor for the presence of passerby.

4. A superimposable lighting pattern projection system associated with a door window, comprising:
a projector; and
a variably light transmissive material on the door window.

5. The superimposable lighting pattern projection system on a door window as in claim 4, further comprising;
a digital control system.

6. The superimposable lighting pattern projection system on a door window as in claim 4, further comprising;
a sensor for the presence of passerby.

7. A projection system for use with a display case, the projection system comprising:
a projector;
a light transmissive panel;
a translucent film affixed to or in proximity of the light transmissive panel;
whereby an image may be projected onto the translucent film.

8. A projection system for use in communicating information about an product on display, the projection system comprising:
a support frame;
a projector;
and a translucent display screen.

9. The projection system of claim 8, wherein the screen translucence may be remotely controlled.
